(19) United States
(12) Patent Application Publication
(10) Pub. No.: US 2026/0226980 A1
(43) Pub. Date: Aug. 6, 2026

(54) SHIFT CONTROL SYSTEM FOR VEHICLE

(71) Applicant: TOYOTA JIDOSHA KABUSHIKI KAISHA, Toyota-shi (JP)

(72) Inventors: Yuji NATSUGA, Miyoshi-shi (JP); Ken FUJIMOTO, Ichinomiya-shi (JP)

(73) Assignee: TOYOTA JIDOSHA KABUSHIKI KAISHA, Toyota-shi (JP)

(21) Appl. No.: 19/346,458

(22) Filed: Sep. 30, 2025

(30) Foreign Application Priority Data
Oct. 2, 2024 (JP) 2024-173206

(51) Int. Cl. F16H 61/02; F16H 59/02; F16H 61/16

(52) U.S. Cl. CPC F16H 61/0213; F16H 59/02; F16H 61/16; F16H 2059/0221; F16H 2061/0244; F16H 2061/161

(57) ABSTRACT

A shift control system configured to execute a shifting operation in accordance with an intention of a driver. The control system comprises: a mode determiner determining a selection of the manual mode; an inhibition determiner determine an inhibition of the automatic upshifting; a manual operation detector determining an execution of a manual downshifting operation; a vehicle speed detector detecting a vehicle speed; and a permissible value determiner determining a permissible vehicle speed to permit an execution of a downshifting. The permissible value determiner is configured to set the permissible vehicle speed to a higher level if the automatic upshifting is inhibited.

### CROSS-REFERENCE TO RELATED APPLICATIONS

The present disclosure claims the benefit of Japanese Patent Application No. 2024-173206 filed on October 2, 2024 with the Japanese Patent Office, the disclosures of which are incorporated herein by reference in its entirety.

### BACKGROUND

### Field of the Disclosure

The embodiment of the present disclosure relates to a system for controlling a shifting operation of a transmission mounted on a vehicle, and more particularly, to a system for controlling an automatic transmission having not only a function to control a speed ratio automatically but also a function to execute a shifting operation of the transmission in response to an execution of a manual shifting operation.

### Discussion of the Related Art

In the prior art, there has been known an automatic transmission having a function to change speed ratio stepwise in accordance with a running condition governed by a vehicle speed and a drive demand represented by a position of an accelerator pedal, and a function to execute a speed change operation in response to an execution of a manual shifting operation. A driver performs a manual shifting operation to accelerate or decelerate a vehicle based on his/her own intention. However, in order to protect a drive unit and to ensure a running stability, a permissible vehicle speed or rotational speed to execute a downshifting is set in the vehicle having such an automatic transmission. For example, in a case that a manual downshifting operation is executed in a condition where a predetermined rotational speed such as an engine speed is higher than the downshifting permissible speed, the downshifting of the transmission is inhibited until the engine speed decreases to the downshifting permissible speed. Thereafter, when the engine speed decreases to the downshifting permissible speed, the downshifting of the transmission is permitted, and the downshifting of the transmission is executed in response to an execution of the manual downshifting operation by the driver.

Thus, when the vehicle travels at a predetermined speed or higher, the downshifting of the transmission is not executed immediately even if the driver performs a manual downshifting operation. That is, the driver is not allowed to operate the vehicle based on his/her intention. In addition, a predetermined time is required to perform the downshifting of the transmission. Therefore, if the manual downshifting operation is executed in a situation where the vehicle is decelerated abruptly, the engine speed may be reduced significantly during a period from a point at which the manual downshifting operation has been executed to a point at which the downshifting is permitted. In such a case, the vehicle may not be allowed to run while maintaining the engine speed to a predetermined level or higher.

Examples of control systems for solving such disadvantages are disclosed in JP-A-2006-258125 and JP-A-2017-067209. According to the teachings of JP-A-2006-258125, when deceleration of a vehicle is equal to or less than a threshold value, the downshifting permissible speed is corrected to the higher speed in accordance with a reduction in the engine speed during a period required to execute the downshifting. On the other hand, according to the teachings of JP-A-2017-067209, the downshifting permissible speed is corrected to the higher speed based on a deceleration at a point when the downshifting operation is executed, and a correction amount is increased in accordance with the deceleration.

Thus, according to the teachings of JP-A-2006-258125 and JP-A-2017-067209, the upper limit speed of the engine speed increased by executing the downshifting is limited to a predetermined speed or less by correcting the downshifting permissible speed. That is, according to the teachings of JP-A-2006-258125 and JP-A-2017-067209, the downshifting permissible speed is limited to the predetermined upper limit speed. Therefore, the downshifting of the transmission is not permitted at a speed which may exceed the predetermined upper limit speed. That is, the driver is not allowed to operate the vehicle based on his/her intention.

### SUMMARY

The embodiment of the present disclosure has been conceived noting the foregoing technical problems, and it is therefore an object of the present disclosure to provide a shift control system configured to execute a shifting operation in accordance with an intention of a driver.

According to the exemplary embodiment the present disclosure, there is provided a shift control system for a vehicle comprising a transmission. A shift mode of the transmission may be selected at least from: a manual mode in which a shifting operation of the transmission is executed in response to a manual shifting operation performed by a driver; and an automatic mode in which the shifting operation of the transmission is executed automatically in accordance with a traveling condition of the vehicle governed at least by a speed of the vehicle and a drive demand. In the vehicle to which the shift control system is applied, an automatic upshifting by which the upshifting is executed automatically to reduce a speed ratio of the transmission may be selectively inhibited. In order to solve the above-explained problems, according to the exemplary embodiment of the present disclosure, the shift control system is provided with a controller that controls the speed ratio in different manners in the automatic mode and in the manual mode. Specifically, the controller comprises: a mode determiner configured to determine that the manual mode is selected; an inhibition determiner configured to determine whether the automatic upshifting is inhibited; a manual operation detector configured to determine that a manual downshifting operation is performed by the driver to increase the speed ratio; a vehicle speed detector configured to detect a value of a speed of the vehicle or a parameter corresponding to the speed of the vehicle; and a permissible value determiner configured to set a permissible value of the speed of the vehicle or the parameter corresponding to the speed of the vehicle at which the downshifting is permitted to be executed in response to an execution of the manual shifting operation. In addition, the permissible value determiner is further configured to set the permissible value to a higher value in a case that the automatic upshifting is inhibited compared to the permissible value set in the case that the automatic upshifting is not inhibited.

In a non-limiting embodiment, the vehicle may further comprise an internal combustion engine whose output power is increased with an increase in the drive demand. In addition, a control for restricting the output power of the internal combustion engine may be executed when a speed of the internal combustion engine increases to a predetermined upper limit speed.

In a non-limiting embodiment, the vehicle may further comprise a switch that is operated manually by the driver to inhibit an execution of the automatic upshifting. In addition, the inhibition determiner may be further configured to determine that the automatic upshifting is inhibited based on a signal transmitted from the switch.

Thus, in the case that the automatic upshifting is inhibited, the downshifting of the transmission is permitted to be executed in response to an execution of the manual downshifting at a higher speed. Whereas, in the case that the automatic upshifting is not inhibited, the downshifting of the transmission is permitted at a speed lower than the speed at which the downshifting of the transmission is permitted in the case that the automatic upshifting is inhibited. Therefore, when the manual downshifting operation is performed by the driver in the situation where the vehicle is traveling at a high speed to some extent, the downshifting of the transmission is executed without waiting for a reduction in the vehicle speed. That is, the downshifting operation of the transmission is executed without delay in response to the execution of the manual shifting operation preformed by the driver. According to the exemplary embodiment of the present disclosure, therefore, the downshifting of the transmission is executed in line with the intention of the driver. For this reason, the driver will not bel frustrated by a delay in execution of the downshifting. In addition, a response of the shifting operation may be improved. In this case, an input speed to the transmission may increase. However, in the case that the automatic upshifting is inhibited, such increase in the input speed to the transmission is expected by the driver. Therefore, the driver will not be frustrated by such increase in the input speed to the transmission, and such increase in the input speed to the transmission will not be recognized erroneously as a malfunction.

Whereas, if the manual shifting operation is performed by the driver in the situation where the automatic upshifting is not inhibited, the downshifting of the transmission is postponed until the permissible vehicle speed drops to the predetermined lower level. Therefore, even if the input speed to the transmission is reduced by the downshifting executed in response to the manual shifting operation performed by the driver, the vehicle speed or the output speed from the transmission has been reduced and the input speed to the transmission will not be increased significantly. For this reason, an execution of the control for reducing the input speed to the transmission is avoided and the driver will not be frustrated by an unexpected reduction in the input speed to the transmission to be caused by such control. Thus, according to the exemplary embodiment of the present disclosure, the input speed to the transmission or the speed of the engine is not restricted to a fixed upper limit speed. For example, in the case that the automatic upshifting is inhibited, the engine speed is allowed to exceed the upper limit speed so that the downshifting of the transmission is executed in response to the manual downshifting operation preformed by the driver without delay. According to the exemplary embodiment of the present disclosure, therefore, the shifting operation of the transmission may be executed based on the driver’s intention.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing one example of a structure of the vehicle to which the shift control system according to the exemplary embodiment of the present disclosure is applied;

FIG. 2 is a block diagram showing functions of a T-ECU serving as a controller of the exemplary embodiment of the present disclosure;

FIG. 3 is a flowchart showing a one example of a routine executed by the controller;

FIG. 4 is a table showing first to third downshifting permissible speeds set in accordance with deceleration; and

FIG. 5 is a time chart showing a timing to execute the downshifting in a case that the automatic upshifting is inhibited and a timing to execute the downshifting in a case that the automatic upshifting is not inhibited.

### DETAILED DESCRIPTION OF THE PREFERRED EMBODIMENT(S)

The exemplary embodiment of the present disclosure will now be explained with reference to the accompanying drawings. Note that the embodiment shown below is merely an example of the present disclosure, and do not limit the present disclosure.

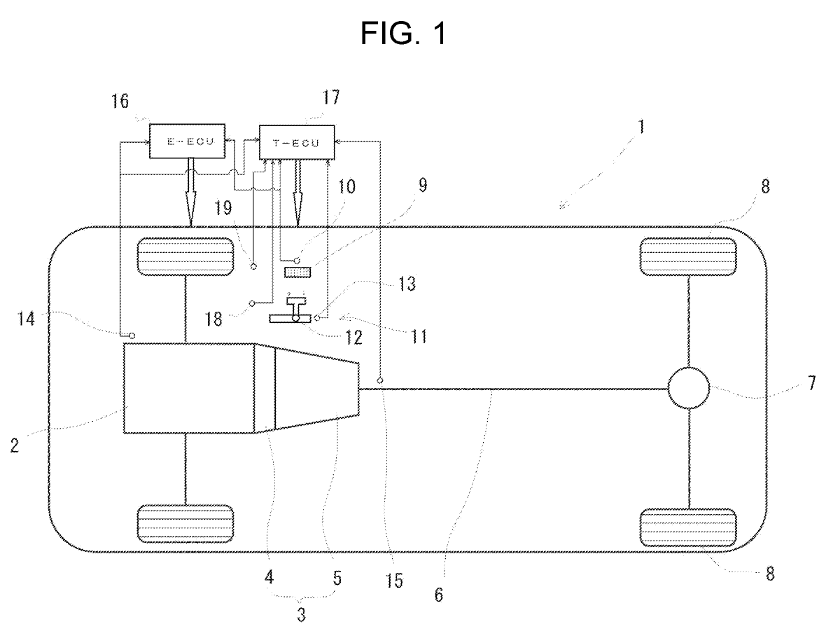

Referring now to FIG. 1, there is shown one example of a structure of a vehicle 1 to which the shift control system according to the exemplary embodiment of the present disclosure is applied. The vehicle 1 comprises an internal combustion engine (hereinafter, simply referred to as the engine) 2 serving as a prime mover, and a transmission 3. As illustrated in FIG. 1, the vehicle 1 is a front-engine rear-drive layout vehicle (FR vehicle). The shift control system according to the exemplary embodiment of the present disclosure may also be applied to a so-called hybrid vehicle in which a prime mover includes an engine and an electric motor (not shown).

A transmission 3 is connected to an output side of the engine 2. For example, a gasoline engine or a diesel engine in which an opening degree of a throttle valve and a fuel injection are controlled electrically may be adopted as the engine 2. The transmission 3 includes a torque converter 4 and a geared transmission 5. The geared transmission 5 includes a plurality of gear pairs having different gear ratios and a plurality of planetary gear sets so that a speed ratio of the geared transmission 5 may be changed stepwise. In the vehicle 1, the gear pair transmitting a driving force and a transmission path of the driving force through the planetary gear set may be switched by an electrically controlled actuator (not shown). An output shaft 6 of the transmission 3 is connected to a differential gear unit 7 as a final reduction unit, and a driving torque is distributed to a pair of rear wheels 8 through the differential gear unit 7.

In order to control an output power of the engine 2, the vehicle 1 is provided with an accelerator pedal 9 operated by a driver (not shown). An operation amount or a position of the accelerator pedal 9 is detected by an accelerator sensor 10. The position of the accelerator pedal 9 is a depression angle of the accelerator pedal 9 measured from the initial position, and corresponds to a drive demand of the exemplary embodiment of the present disclosure.

A shift mode of the transmission 3 may be selected at least from an automatic mode in which the shifting operation of the transmission 3 is executed automatically in accordance with a traveling condition of the vehicle 1 governed by a plurality of parameters including at least a speed of the vehicle 1 and a drive demand, and a manual mode in which the shifting operation of the transmission 3 is executed in response to a manual shifting operation performed by the driver. In order to select the shift mode and the gear stage of the transmission 3, the vehicle 1 is provided with a shifting device 11. As the conventional shifting devices, the shifting device 11 includes a lever 12. According to the exemplary embodiment of the present disclosure, the lever 12 is moved among a parking (P) position at which the vehicle 1 is parked, a reverse (R) position at which the vehicle 1 is reversed, a neutral (N) position at which the torque transmission to the rear wheels 8 is interrupted, a drive (D) position at which the gear stage is shifted automatically among forward stages, a manual position at which the gear stage is fixed, an up position at which the gear stage is shifted to a stage one stage higher than the current stage, and a down position at which the gear stage is shifted to a stage one stage lower than the current stage. The position of the lever 12 is detected by a position sensor 13.

The vehicle 1 is further provided with an engine speed sensor 14 that detects a speed of the engine 2, and a vehicle speed sensor 15 that detects a speed of the vehicle 1. For example, the engine speed sensor 14 may be adapted to detect the number of revolutions of an output shaft such as a crankshaft (not shown) of the engine 2, and the vehicle speed sensor 15 may be adapted to detect the number of revolutions of the output shaft 6 of the transmission 3.

The engine 2 is controlled by an engine control unit (hereinafter, referred to as the E-ECU) 16. The E-ECU16 comprises a microcomputer including an arithmetic element (i.e., a CPU) and a storage element (i.e., a RAM and a ROM), and performs a calculation using incident data and data stored in advance. A calculation result is transmitted from the E-ECU16 in the form of a control signal. For example, detection signals are transmitted to the E-ECU16 from the accelerator sensor 10 and the engine speed sensor 14, and the E-ECU16 transmits command signals for controlling an opening degree of the throttle valve and a fuel injection.

On the other hand, the transmission 3 is controlled by a transmission control unit (hereinafter, referred to as the T-ECU) 17. Likewise, the T-ECU17 comprises a microcomputer including an arithmetic element (i.e., a CPU) and a storage element (i.e., a RAM and a ROM), and performs a calculation using incident data and data stored in advance. A calculation result is transmitted from the T-ECU16 also in the form of a control signal. For example, detection signals are transmitted to the T-ECU17 from the accelerator sensor 10, the engine speed sensor 14, the position sensor 13, and the vehicle speed sensor 15, and the T-ECU17 transmits a shift signal for setting the gear stage or the speed ratio, an upshift signal for shifting the gear stage to a stage one stage higher than the current stage, and a downshift signal for shifting the gear stage to a stage one stage lower than the current stage,

In order to shift the gear stage of the transmission 3 automatically in the automatic mode, a shift map is stored in the T-ECU17. The shift map is configured to determine the gear stage based on a drive demand represented by a position of the accelerator pedal 9, and a speed of the vehicle 1. That is, in the automatic mode, a gear stage (i.e., a speed ratio) of the transmission 3 is determined with reference to the shift map. Whereas, in the manual mode, a gear stage (i.e., a speed ratio) of the transmission 3 is selected based on the command signal transmitted in response to a manual shifting operation performed by the driver without referring to the shift map. In addition, a speed of the vehicle 1 or the engine 2 at which the downshifting of the transmission 3 is permitted to be executed in response to the manual shifting operation performed by the driver (hereinafter, referred to as the downshifting permissible speed) is stored in the T-ECU17. Such downshifting permissible speed is determined at the design phase based on a result of an experiment or a simulation conducted in advance. Further, an automatic upshifting permissible speed at which the automatic upshifting of the transmission 3 is permitted is also stored in the T-ECU17.

The vehicle 1 is further provided with a switch 18 that is operated manually by the driver to inhibit an execution of the automatic upshifting for upshifting the gear stage of the transmission 3 automatically in accordance with a traveling condition of the vehicle 1 governed by a speed of the vehicle 1 and a position of the accelerator pedal 9. The control to restrict the execution of the automatic upshifting is referred to as a vehicle stability control (VSC) or traction control (TRC, TCS, or TCL) included in the VSC. By executing these controls, even if an increase in a speed of the vehicle 1 is determined erroneously due to slip of any of the rear wheels 8, the upshifting of the transmission 3 is inhibited and the current speed ratio is maintained. In addition, even if an increase in a speed of the vehicle 1 is determined erroneously due to slip of the rear wheels 8 resulting from e.g., a run off, the upshifting of the transmission 3 is inhibited by these controls to prevent a reduction in the driving torque.

The vehicle 1 is further provided with a paddle switch 19 arranged in a steering column (not shown). When the driver operates the paddle switch 19 by hand, the downshift signal or the upshift signal is transmitted therefrom to the T-ECU17.

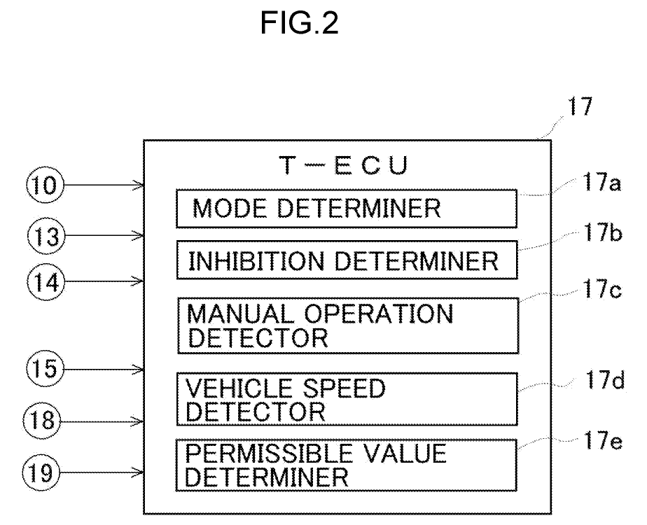

Thus, the T-ECU17 serves as the controller of the exemplary embodiment of the present disclosure to execute the shifting operation of the transmission 3 upon reception of the signals from the above-mentioned sensors using the data stored in advance. Specifically, the T-ECU17 is configured to set the downshifting permissible speed when the driver performs the manual shifting operation according to whether the automatic upshifting is restricted. Functions of the T-ECU17 are shown in FIG. 2 in more detail.

As shown in FIG. 2, the T-ECU17 comprises a mode determiner 17a, an inhibition determiner 17b, a manual operation detector 17c, a vehicle speed detector 17d, and a permissible value determiner 17e. The mode determiner 17a is configured to determine that the manual mode is selected. In the manual mode, the shifting operation of the transmission 3 is executed based on the command signal transmitted in response to an execution of the manual shifting operation performed by the driver. For example, in a case that the lever 12 is positioned at the manual position in the shifting device 11, the mode determiner 17a determines that the manual mode is selected based on the signal transmitted from the position sensor 13. The inhibition determiner 17b is configured to determine whether or not the automatic upshifting of the transmission 3 is inhibited. For example, the automatic upshifting is permitted if a switch (not shown) for activating the above-explained VSC or TRC is ON. By contrast, the automatic upshifting is inhibited if the above-mentioned switch is OFF. Therefore, the inhibition determiner 17b determines whether or not the automatic upshifting is inhibited based on the signal transmitted from the above-mentioned switch.

The manual operation detector 17c is configured to determine that a manual downshifting operation is performed by the driver. For example, the manual operation detector 17c determines that the manual downshifting operation is performed by the driver based on the downshift signal transmitted from the position sensor 13 when the lever 12 is moved to the down position in the shifting device 11. The vehicle speed detector 17d is configured to detect the speed of the vehicle 1 based on the detection signal transmitted from the vehicle speed sensor 15. The permissible value determiner 17e is configured to set the above-mentioned downshifting permissible speed or a permissible value of a parameter corresponding to a speed of the vehicle 1. Values of the downshifting permissible speed for the case that the automatic upshifting is inhibited and for the case that the automatic upshifting is not inhibited may be determined in advance and stored in the T-ECU17. In addition, the downshifting permissible speed may be set in accordance with a deceleration of the vehicle 1 at a point when the downshifting is executed.

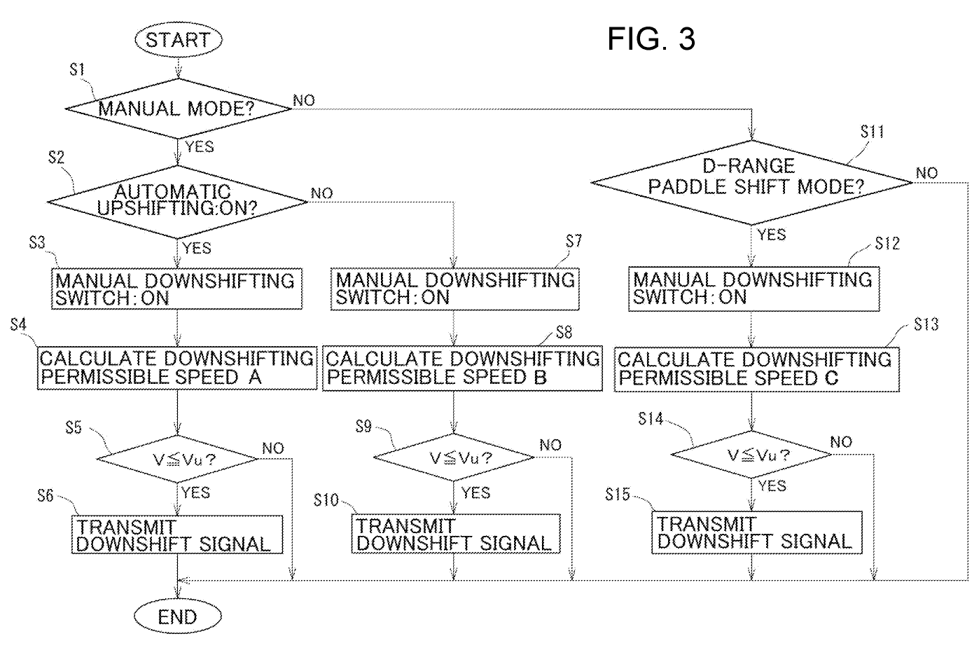

Turning to FIG. 3, there is shown an example of a routine executed by the T-ECU17. The routine shown in FIG. 3 is repeated at predetermined short time intervals as long as the vehicle 1 is in a power-on state or traveling. At step S1, it is determined whether or not the manual shift control is in execution. In other words, at step S1, it is determined whether or not the manual mode is selected. Specifically, such determination of step S1 may be made by the mode determiner 17a.

If the manual mode is selected so that the answer of step S1 is YES, the routine progresses to step S2 to determine whether the automatic upshifting control is ON. That is, at step S2, it is determined whether or not the automatic upshifting is inhibited. If the above-explained VSC or TRC is activated and the automatic upshifting is not prohibited so that the answer of step S2 is YES, the routine progresses to step S3 to detect an ON signal transmitted from a manual downshifting switch (SW). For example, when the lever 12 is moved to the down position in the shifting device 11, the downshift signal (i.e., the ON signal) is transmitted from the position sensor 13, and the manual operation detector 17c determines that the manual downshifting operation is performed based on the downshift signal.

Then, at step S4, a first downshifting permissible speed A is calculated. Specifically, the first downshifting permissible speed A is a design value which is set to a speed at which a speed of the engine 2 will not to be raised to a predetermined upper limit speed even if the downshifting of the transmission 3 is executed, and is stored in advance in the T-ECU17 in the form of a map. The first downshifting permissible speed A may be set for each of the gear stages of the transmission 3, and may be selected according to the gear stage at a point when the manual downshifting operation is performed. In addition, the first downshifting permissible speed A may be corrected based on the deceleration of the vehicle 1 and an execution or inexecution of a braking operation.

Thereafter, at step S5 of, it is determined whether a current vehicle speed V is equal to or lower than the automatic upshifting permissible speed Vu stored in advance. If the answer of step S5 is YES, the routine progresses to step S6 to transmit the downshift signal to execute a downshifting of the transmission 3. Thereafter, the routine returns. By contrast, if the answer of step S5 is NO, the routine returns without transmitting the downshift signal.

Whereas, if a switch (not shown) for activating the above-explained VSC or TRC is OFF, that is, if the automatic upshifting is inhibited so that the answer of step S2 is NO, the routine progresses to step S7 to detect the ON signal transmitted from the manual downshifting switch (SW) as the foregoing step S3.

Then, at step S8, a second downshifting permissible speed B is calculated. The second downshifting permissible speed B is a design value which is set to a value greater than the first downshifting permissible speed A. Specifically, the second downshifting permissible speed B is set without being restricted by the above-mentioned upper limit speed of the engine 2, and is stored in advance in the T-ECU17 in the form of a map. The second downshifting permissible speed B may also be set for each of the gear stages of the transmission 3, and may be selected according to the gear stage at a point when the manual downshifting operation is performed. In addition, the second downshifting permissible speed B may be corrected based on the deceleration of the vehicle 1 and an execution or inexecution of a braking operation.

Thereafter, at step S9, it is determined whether a current vehicle speed V is equal to or lower than the automatic upshifting permissible speed Vu stored in advance. If the answer of step S9 is YES, the routine progresses to step S10 to transmit the downshift signal to execute a downshifting of the transmission 3. Thereafter, the routine returns. By contrast, if the answer of step S9 is NO, the routine returns without transmitting the downshift signal.

As described above, the vehicle 1 is provided with the paddle switch 19, and in a D-range paddle shift mode, the speed of the transmission 3 may also be shifted by operating the paddle switch 19. For example, the D-range paddle shift mode may be selected by activating the paddle switch 19. Specifically, in the D range paddle shift mode, even if the lever 12 is positioned at the D position in the shifting device 11, the gear stage of the transmission 3 is shifted manually by operating the paddle switch 19.

Accordingly, if the answer of step S1 is NO, the routine progresses to step S11 to determine whether the shift mode is in the D-range paddle shift mode. If the paddle switch 19 is not activated so that the answer of step S11 is NO, the routine returns. By contrast, if the answer of step S11 is YES, the routine progress to step S12 to detect the ON signal transmitted from the manual downshifting switch (SW) as the foregoing steps S3 and S7. In this case, specifically, the downshift signal transmitted from the paddle switch 19 by manually operating the paddle switch 19 is detected.

Then, at step S13, a third downshifting permissible speed C is calculated. The third downshifting permissible speed C is a design value which is set to a value smaller than the first downshifting permissible speed A. Specifically, the third downshifting permissible speed C is set taking account of the above-mentioned upper limit speed of the engine 2, and is stored in advance in the T-ECU17 in the form of a map. The third downshifting permissible speed C may also be set for each of the gear stages of the transmission 3, and may be selected according to the gear stage at a point when the manual downshifting operation is performed. In addition, the third downshifting permissible speed C may be corrected based on the deceleration of the vehicle 1 and an execution or inexecution of a braking operation.

Thereafter, at step S14, it is determined whether a current vehicle speed V is equal to or lower than the automatic upshifting permissible speed Vu stored in advance. If the answer of step S14 is YES, the routine progresses to step S15 to transmit the downshift signal to execute a downshifting of the transmission 3. Thereafter, the routine returns. By contrast, if the answer of step S14 is NO, the routine returns without transmitting the downshift signal.

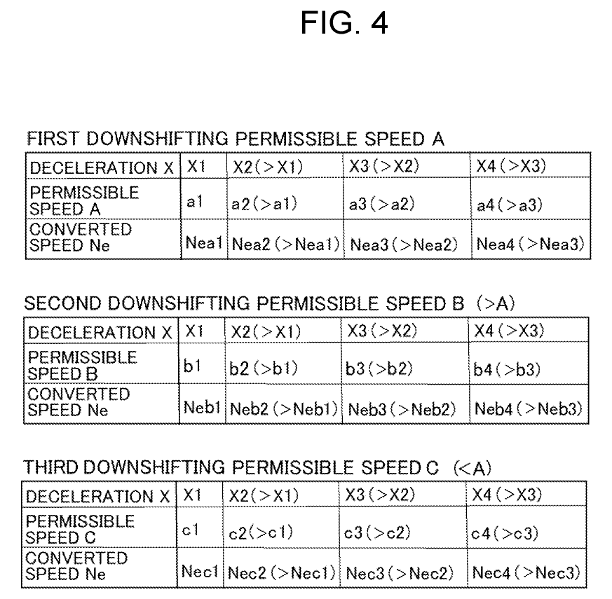

Examples of the first downshifting permissible speed A, the second downshifting permissible speed B, and the third downshifting permissible speed C are shown in FIG. 4. As described above, the second downshifting permissible speed B is highest, the first downshifting permissible speed A is lower than the second downshifting permissible speed B, and the third downshifting permissible speed C is lower than the first downshifting permissible speed A. In the example shown in FIG. 4, the deceleration X1 is "0", and each of the downshifting permissible speeds A, B, and C are set each to a larger value with an increase in the deceleration X. This is because the speed of the vehicle 1 may decrease significantly during execution of the downshifting if the vehicle 1 is decelerated significantly.

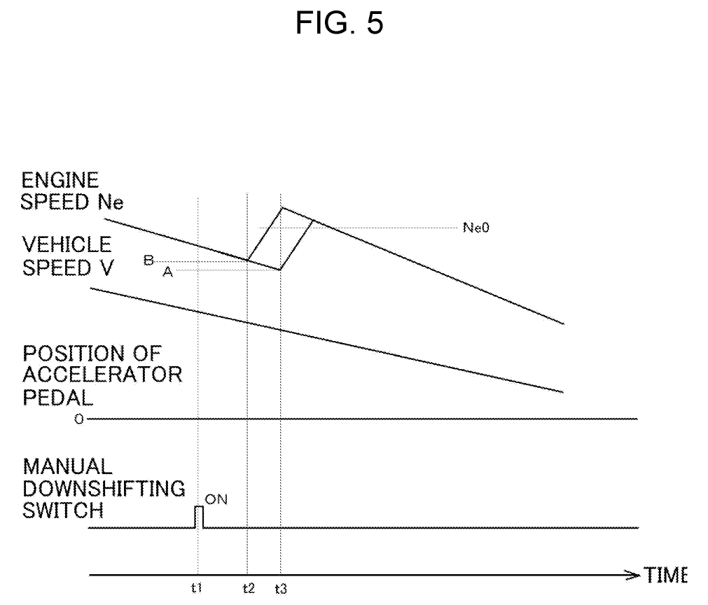

FIG. 5 shows a difference between the timing to execute the downshifting in the case that the automatic upshifting is inhibited and the timing to execute the downshifting in the case that the automatic upshifting is not inhibited. In the example shown in FIG. 5, the vehicle 1 is decelerating without depressing the accelerator pedal 9. At point t1, an engine speed Ne is higher than the second downshifting permissible speed B, and the lever 12 of the shifting device 11 is moved to the down position so that the downshift signal is transmitted from the position sensor 13.

In this situation, if the automatic upshifting is inhibited, the second downshifting permissible speed B is obtained. In this case, therefore, the downshifting of the transmission 3 is executed at point t2 when a vehicle speed V has decreased to the second downshifting permissible speed B. Consequently, the engine speed Ne increases to a level determined as a product of a speed ratio after the downshifting and the vehicle speed V, and then gradually decreases with a reduction in the vehicle speed V. In this case, the engine speed Ne may exceed a predetermined target speed (or an upper limit speed) Ne0. Therefore, if the accelerator pedal 9 is depressed in this situation, a control for restricting the output power of the engine 2 such as a fuel cut control or an ignition retard control may be executed so as to reduce the output power of the engine 2. However, such controls are usually executed in association with an execution of the manual shifting operation, and the behavior of the vehicle 1 is changed inevitably as a result of carrying out those controls. Therefore, the driver will not be frustrated even if such controls are executed.

Whereas, in the case that the automatic upshifting is not inhibited, the first downshifting permissible speed A is obtained. In this case, therefore, the downshifting is executed at point t3 when the vehicle speed V decreases to the first downshifting permissible speed A which is lower than the second downshifting permissible speed B. In this case, the engine speed Ne also increases to the level determined as a product of the speed ratio after the downshifting and the vehicle speed V. However, since the vehicle speed V has decreased at point t3 at which the downshifting is executed, the engine speed Ne to be increased after the completion of the downshifting is lower than that of the case in which the automatic upshifting is inhibited. Therefore, when the accelerator pedal 9 is depressed and an upshifting is executed after the downshifting, the engine speed Ne decreases immediately with a reduction in the speed ratio, and the above-mentioned controls such as the fuel cut control and the ignition retard control will not be executed.

Thus, in the case that the automatic upshifting is inhibited, the second downshifting permissible speed B at which the downshifting is executed in response to the manual downshifting operation is set to a higher level as compared to the first downshifting permissible speed A employed in the case that the automatic upshifting is not inhibited. According to the exemplary embodiment of the present disclosure, therefore, the downshifting of the transmission 3 may be expected without delay in response to the manual downshifting operation. For this reason, the driver will not bel frustrated by a delay in execution of the downshifting. In addition, a response of the shifting operation may be improved.

The present disclosure should not be limited to the foregoing embodiment, and may be modified arbitrarily as necessary. For example, the routine shown in FIG. 3 may be modified to return immediately in the case that the answer of the step S1 is NO, instead of progressing to step S11. That is, the control system according to the present disclosure may also be applied to a vehicle without having the paddle switch. In addition, a shifting device having a button for instructing an execution of the shifting operation may also be employed instead of the shifting device 11 having the lever 12. Further, a rotational speed of a wheel may also be employed as a parameter representing the vehicle speed instead of the rotational speed of the output shaft of the transmission.

What is claimed is:

1. A shift control system for a vehicle comprising a transmission,
wherein a shift mode of the transmission may be selected at least from
a manual mode in which a shifting operation of the transmission is executed in response to a manual shifting operation performed by a driver, and
an automatic mode in which the shifting operation of the transmission is executed automatically in accordance with a traveling condition of the vehicle governed at least by a speed of the vehicle and a drive demand, and
an automatic upshifting by which the upshifting is executed automatically to reduce a speed ratio of the transmission may be selectively inhibited,
the shift control system comprises a controller that controls the speed ratio in different manners in the automatic mode and in the manual mode, and
the controller comprises
a mode determiner configured to determine that the manual mode is selected,
an inhibition determiner configured to determine that the automatic upshifting is inhibited,
a manual operation detector configured to determine that a manual downshifting operation is performed by the driver to increase the speed ratio,
a vehicle speed detector configured to detect a value of a speed of the vehicle or a parameter corresponding to the speed of the vehicle, and
a permissible value determiner configured to set a permissible value of the speed of the vehicle or the parameter corresponding to the speed of the vehicle at which the downshifting is permitted to be executed in response to an execution of the manual shifting operation, and
the permissible value determiner is further configured to set the permissible value to a higher value in a case that the automatic upshifting is inhibited compared to the permissible value set in the case that the automatic upshifting is not inhibited.

2. The shift control system as claimed in claim 1,
wherein the vehicle further comprises an internal combustion engine whose output power is increased with an increase in the drive demand, and
a control for restricting the output power of the internal combustion engine is executed when a speed of the internal combustion engine increases to a predetermined upper limit speed.

3. The shift control system as claimed in claim 1,
wherein the vehicle further comprises a switch that is operated manually by the driver to inhibit an execution of the automatic upshifting, and
the inhibition determiner is further configured to determine that the automatic upshifting is inhibited based on a signal transmitted from the switch.

4. The shift control system as claimed in claim 2,
wherein the vehicle further comprises a switch that is operated manually by the driver to inhibit an execution of the automatic upshifting, and
the inhibition determiner is further configured to determine that the automatic upshifting is inhibited based on a signal transmitted from the switch.
